(19) United States
(12) Patent Application Publication
(10) Pub. No.: US 2020/0065874 A1
(43) Pub. Date: Feb. 27, 2020

(54) SYSTEMS AND METHODS FOR LOCAL SOURCING OF GOODS IN ONLINE COMMERCE

(71) Applicant: Nathan Zeidwerg, Palo Alto, CA (US)

(72) Inventor: Nathan Zeidwerg, Palo Alto, CA (US)

(21) Appl. No.: 16/538,031

(22) Filed: Aug. 12, 2019

Related U.S. Application Data
(60) Provisional application No. 62/720,722, filed on Aug. 21, 2018.

(51) Int. Cl. G06Q 30/06

(52) U.S. Cl. CPC G06Q 30/0625; G06Q 30/0641

(57) ABSTRACT

Systems and methods for local sourcing of goods in online commerce are provided. In various embodiments methods include receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product. In some instances methods further include filtering a plurality of the plurality of verified merchants based on the threshold geographic distance from the client geographic location, the filtering the plurality of verified merchants comprising selecting a plurality of local merchants, the plurality of local merchants being a fraction of a plurality of verified merchants that meet the threshold geographic distance from the client geographic location.

### CROSS REFERENCE TO RELATED APPLICATION

This application claims the priority benefit of U.S. Provisional Patent Application Ser. No. 62/720,722 filed on Aug. 21, 2018 and titled “Systems and Methods for Local Sourcing of Goods in Online Commerce,” which are hereby incorporated by reference in its entirety for all purposes including all references cited therein.

### FIELD OF THE TECHNOLOGY

Embodiments of the disclosure relate to sourcing local goods in online commerce. In particular, the present disclosure relates to systems and methods providing for local sourcing of goods and services in online commerce.

### SUMMARY

In some embodiments the present disclosure is directed to a system of one or more computers which can be configured to perform particular operations or actions by virtue of having software, firmware, hardware, or a combination thereof installed on the system that in operation causes or cause the system to perform actions and/or method steps as described herein.

Some embodiments of the present technology include a system for local sourcing of goods in online commerce, comprising: a secure switch operable to communicate bilaterally with at least one client device; at least one gateway server electronically communicating with the secure switch, the least one gateway server comprising; at least one processor; and a memory storing processor-executable instructions, wherein the at least one processor is configured to implement the following operations upon executing the processor-executable instructions: (i) receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product; (ii) receiving, from a plurality of prospective merchants, merchant geographic information associated with the plurality of prospective merchants relative to the query information for the product; (iii) validating the merchant geographic information associated with the plurality of prospective merchants based on the query information for the product; (iv) converting a portion of the plurality of prospective merchants to a plurality of verified merchants based on the validating operation; (v) filtering the plurality of the plurality of verified merchants based on the threshold geographic distance from the client selected geographic location, the filtering the plurality of verified merchants comprising selecting a plurality of local merchants, the plurality of local merchants being a fraction of the plurality of verified merchants that meet the threshold geographic distance from the client geographic location; and (vi) displaying the plurality of local merchants to the consumer using the client device associated with the consumer.

In some embodiments the client geographic location is a delivery address.

In various embodiments the displaying the plurality of local merchants to the consumer using the client device associated with the consumer comprises displaying an adjustable radius of the geographic distance between the delivery address and the manufacturing geographic location of the product.

In some embodiments the displaying the plurality of local merchants to the consumer using the client device associated with the consumer comprises displaying an adjustable radius of the geographic distance between the delivery address and the retail geographic location of the product.

In various embodiments the displaying the plurality of local merchants to the consumer using the client device associated with the consumer comprises displaying both an adjustable radius of the geographic distance between the delivery address and the manufacturing geographic location of the product, and an adjustable radius of the geographic distance between the delivery address and the retail geographic location of the product.

In some embodiments the threshold geographic distance of the product from the client geographic location is further a function of order geographic location fulfillment for the product by an agent of the merchant.

In some embodiments the threshold geographic distance of the product from the client geographic location is further a function of the current geographic location of the client device. In some embodiments the threshold geographic distance is a saved geographic location of the client device. For example, the saved geographic location of the client device may be used for gifting or when a user is traveling.

In various embodiments the threshold geographic distance of the product from the client geographic location is further a function of delivery emissions for the product, the delivery emissions for the product being a function of emissions generated from travel of the product from the manufacturing geographic location of the product to the retail location of the product, and a function of emissions generated from travel of the product from the retail geographic location of the product to the delivery address.

In some embodiments the displaying the plurality of local merchants to the consumer using the client device associated with the consumer further comprises displaying the delivery emissions for the product from the plurality of local merchants.

In various embodiments the at least one processor is further configured to implement the operation receiving a threshold emissions criteria from the client, the threshold emissions criteria from the client being a maximum total emissions generated from travel of the product from the manufacturing geographic location of the product to the retail location of the product and emissions generated from travel of the product from the retail geographic location of the product to the delivery address.

In some embodiments the product from the plurality of local merchants does not meet the threshold emissions criteria from the client; and the at least one processor is further configured to implement the operation of displaying an alternative product, the alternative product meeting the threshold emissions criteria from the client.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that can be used to practice aspects of the present technology.

FIG. 2 is a simplified diagram of concepts according to exemplary embodiments of the present technology.

FIG. 3 is simplified diagrams of concepts according to exemplary embodiments of the present technology.

FIG. 4 is simplified diagrams of local implementation according to exemplary embodiments of the present technology.

FIG. 5 is a simplified diagram of concepts according to exemplary embodiments of the present technology.

FIG. 6 is exemplary flow diagram according to exemplary embodiments of the present technology.

FIG. 7 illustrates a computer system according to exemplary embodiments of the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Some embodiments the present technology encompasses a system for local sourcing of goods in online commerce, including: a prioritization engine, the prioritization engine identifying a source for each of a plurality of goods identified by a user, the source including a manufacturing source and a retail source for each of the plurality of goods; and a filter, the filter sorting the plurality of goods based on a geographic distance between a location of the user and both the manufacturing source and the retail source to allow the user to select locally sourced goods of the plurality of goods. For example, the system for local sourcing of goods in online commerce may be a plug-in (i.e., add-on, extension) to implement the features and functionalities described herein.

In various embodiments of the present technology the location of the user is a delivery address of the user. For example, the user may enter their zip code. In some embodiments, the system for local sourcing of goods in online commerce includes the filter displaying an adjustable radius of the geographic distance between the delivery address of the user (e.g., zip code) and both the retail source and the manufacturing source for each of the plurality of goods.

In some embodiments, a filter allows a shopper to select or prioritize goods (or services) based on a geographical distance between the source of the goods and the shopper's specified location. In exemplary embodiments, the shopper enters the name or category of the desired product, for example a broom. The search engine initially returns a list of brooms matching the search criteria of brooms. Once the initial list of brooms is returned, a prioritization engine operates on the returned list to identify (where possible) the source of manufacture and the source of retail sale for each of the brooms on the list. For example, the first broom on the returned list is the Zephyr 30, Blue Handle, Size 8. The prioritization engine then automatically searches the returned description for information about the location of the manufacturer and the retailer. Finding no location information, the prioritization engine searches the internet for Zephyr brooms and determines that this broom is manufactured at 200 Mitchell Road, Sedalia, Mo. 65301-2114 USA. A second internet search locates the nearest retailer of the Zephyr 30 to be Ace Hardware located at 441 1ST ST, LOS ALTOS, Calif. 94022-3630 USA.

In exemplary embodiments, once the prioritization engine completes its searches, a sort is performed on the list of brooms and displayed, sorting the brooms based on the shopper's preference of manufacturing location or retail location.

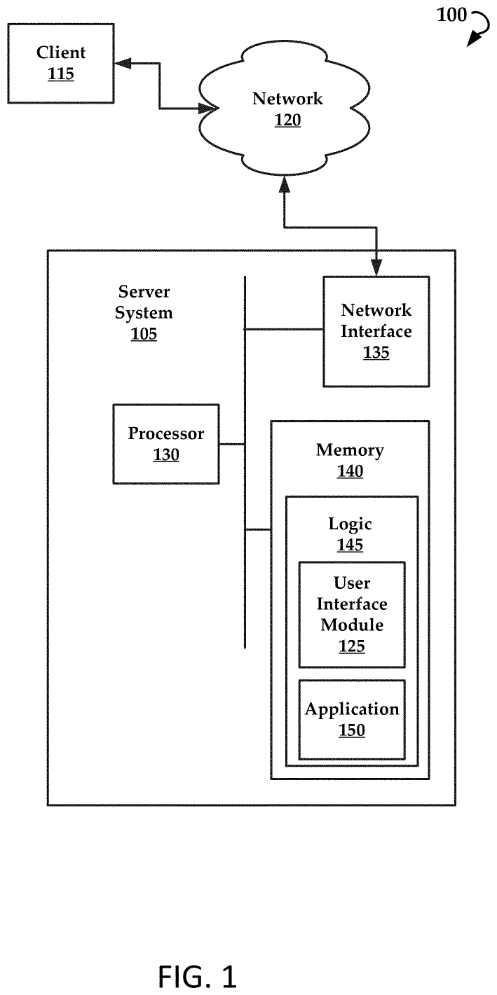

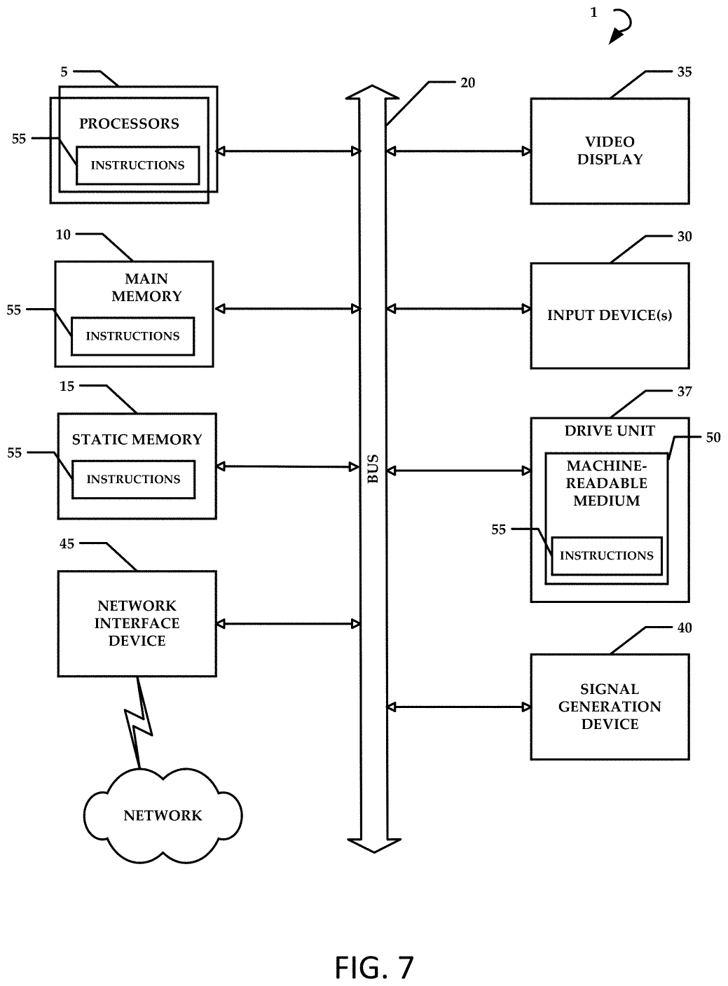

FIG. 1 illustrates an exemplary architecture 100 for practicing aspects of the present technology. The architecture comprises a server system, hereinafter “system 105” that is configured to provide various functionalities, which are described in greater detail throughout this document. Generally the system 105 is configured to communicate with client devices, such as client 115. An example of a computing device that can be utilized in accordance with the present technology is described in greater detail with respect to FIG. 7. In some embodiment the system 105 comprises a secure switch operable to communicate bilaterally with at least one client device (e.g., client 115). In various embodiments the system 105 comprises at least one gateway server electronically communicating with the secure switch.

The system 105 may communicatively couple with the client 115 via a public or private network, such as network 120. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 105 generally comprises a processor, 130, a network interface 135, and a memory 140. According to some embodiments, the memory 140 comprises logic 145 (e.g., instructions) that can be executed by the processor 130 to perform various methods. For example, the logic may include a user interface module 125 as well as a data aggregation and correlation application (hereinafter application 150) that is configured to provide the functionalities described in greater detail herein.

It will be understood that the functionalities described herein, which are attributed to the system 105 and application 150 may also be executed within the client 115. That is, the client 115 may be programmed to execute the functionalities described herein. In other instances, the system 105 and client 115 may cooperate to provide the functionalities described herein, such that the client 115 is provided with a client-side application that interacts with the system 105 such that the system 105 and client 115 operate in a client/server relationship. Complex computational features may be executed by the server (e.g., the system 105), while simple operations that require fewer computational resources may be executed by the client 115, such as data gathering and data display.

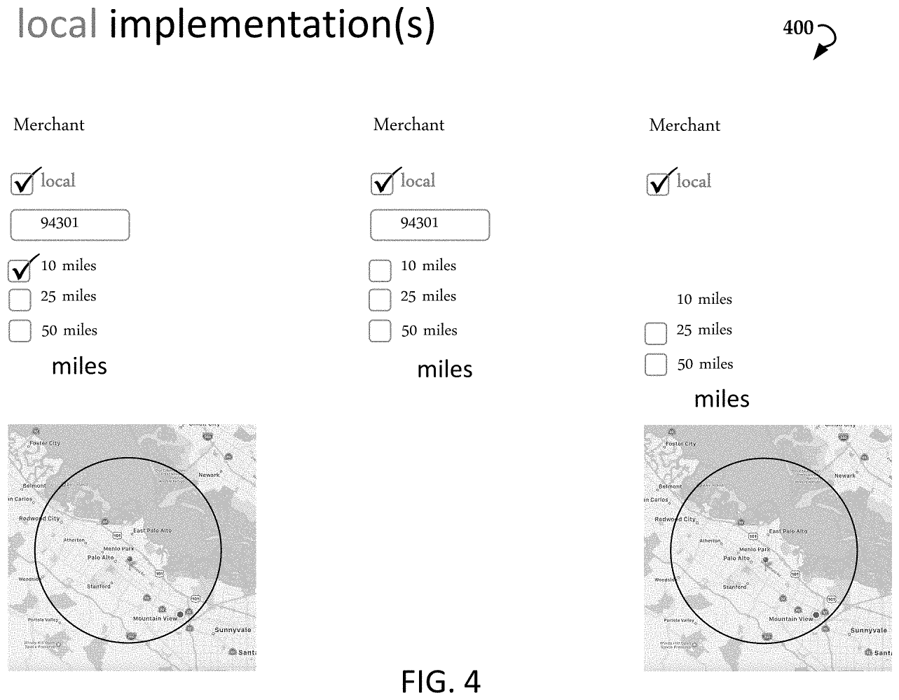

In general, the user interface module 125 may be executed by the system 105 to provide various graphical user interfaces (GUIs) that allow users to interact with the system 105. In some instances, GUIs are generated by execution of the application 150 itself. Users may interact with the system 105 using, for example, a client 115. The system 105 may generate web-based interfaces for the client. For example, FIG. 4 shows local implementation with the adjustable radius being 10 miles for the retail location for the locally sourced goods.

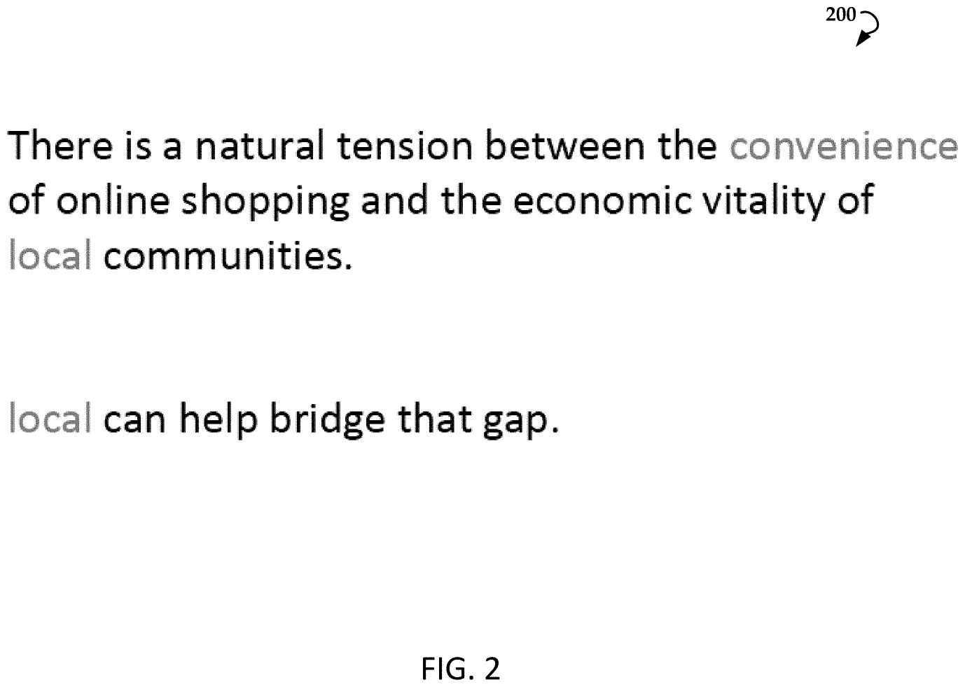

FIG. 2 is a simplified diagram of concepts 200 according to exemplary embodiments of the present technology. For example, a natural tension exists between the convenience of online shopping and economic vitality of local communities.

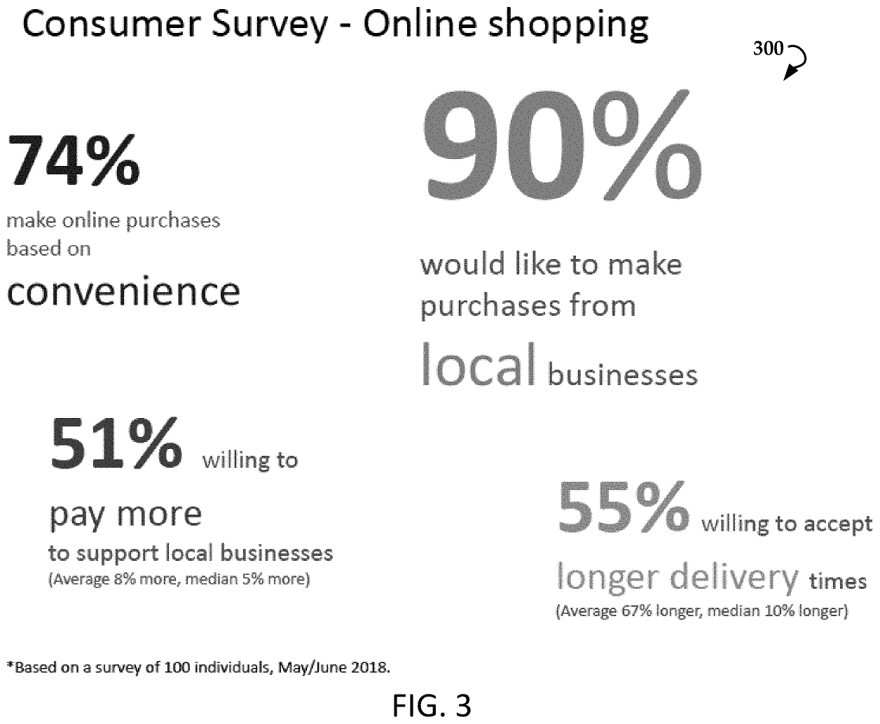

FIG. 3 is simplified diagrams of concepts 300 according to exemplary embodiments of the present technology. For example, consumer surveys related to online shopping show that 74% of surveyed consumers make online purchases based on convenience. Furthermore, 90% of surveyed consumers would like to make purchases from local businesses. Significantly, 51% of surveyed consumers would be willing to pay more to support local businesses. Moreover, 55% of surveyed consumers would be willing to accept longer delivery times.

FIG. 4 is a simplified diagram of local implementation 400 according to exemplary embodiments of the present technology. In exemplary embodiments, the system for local sourcing of goods in online commerce includes the filter displaying an adjustable radius of the geographic distance between the delivery address of the user and both the retail source and the manufacturing source for each of the plurality of goods. For example, the simplified diagram of local implementation 400 of FIG. 4 shows the adjustable radius being 10 miles for the retail location (e.g., Amazon Services, Walmart Marketplace, and Jet marketplace) for the locally sourced goods.

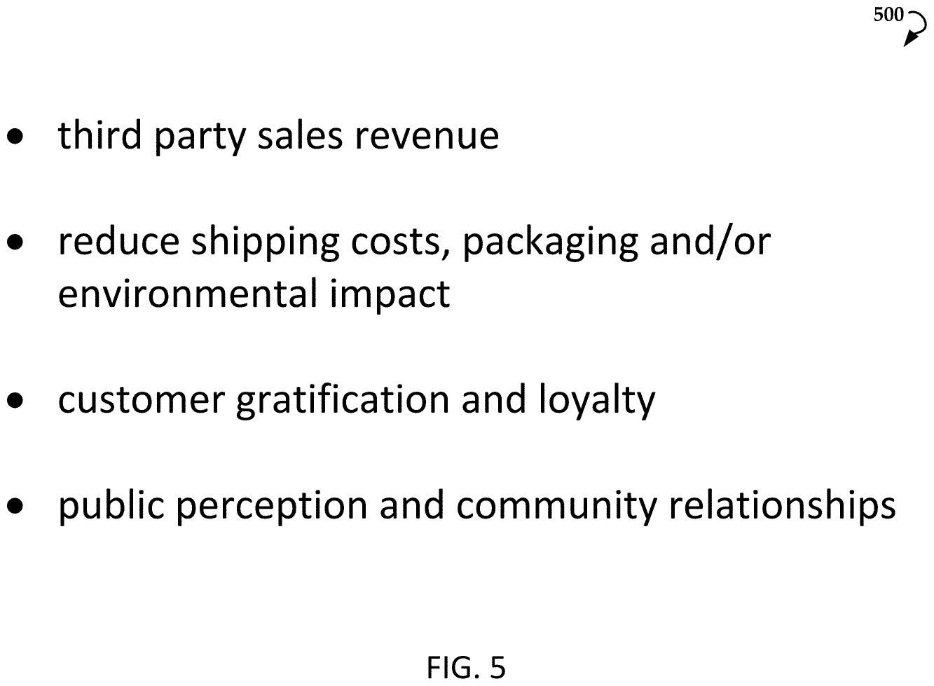

FIG. 5 is a simplified diagram of concepts 500 according to exemplary embodiments of the present technology. For example, embodiments of the present technology are designed to enhance: third-party sales revenue, the reduction of shipping costs, packaging and/or environmental impact, customer gratification and loyalty, and public perception and community relationships.

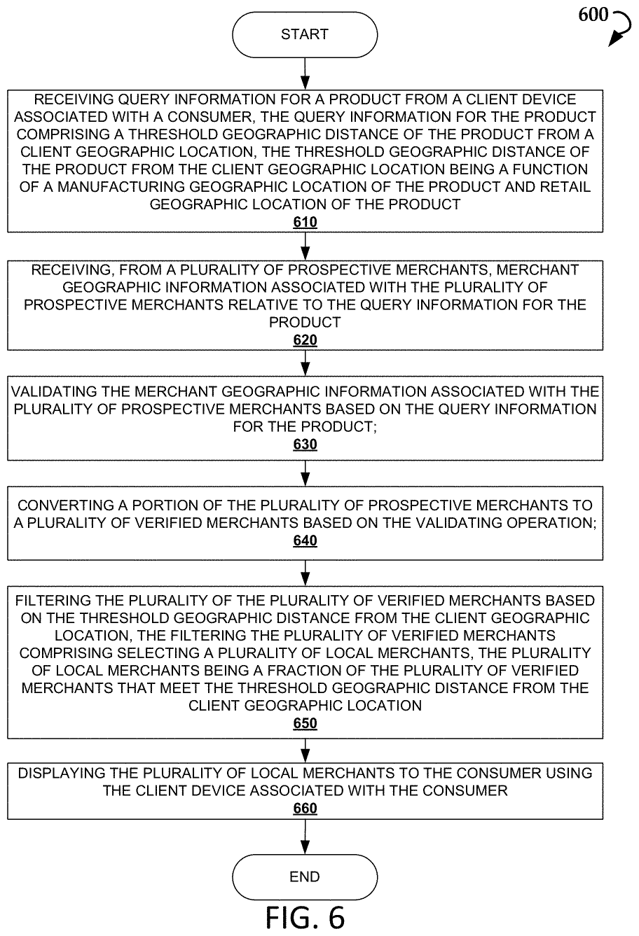

FIG. 6 is a process flow diagram showing a method 600 for providing a comprehensive fall risk assessment according to one or more example embodiments. The method 600 may be performed by processing logic that may comprise hardware (e.g., dedicated logic, programmable logic, and microcode), software (such as software run on a general-purpose computer system or a dedicated machine), or a combination thereof. In one or more example embodiments, the processing logic resides at the client 115, or the server system 105, or combinations thereof.

As shown in FIG. 6, the method 600 may commence at operation 610, with receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product.

In various embodiments the client geographic location a location of the client device or another selected location used for gifting. For example, a location used for delivery while not in a normal delivery location when a consumer is travelling.

At operation 620, the method 600 may proceed with receiving, from a plurality of prospective merchants, merchant geographic information associated with the plurality of prospective merchants relative to the query information for the product.

At operation 630, the method 600 may include validating the merchant geographic information associated with the plurality of prospective merchants based on the query information for the product.

At operation 640, the method 600 may proceed with converting a portion of the plurality of prospective merchants to a plurality of verified merchants based on the validating operation.

At operation 650, the method 600 may include filtering the plurality of the plurality of verified merchants based on the threshold geographic distance from the client geographic location, the filtering the plurality of verified merchants comprising selecting a plurality of local merchants, the plurality of local merchants being a fraction of the plurality of verified merchants that meet the threshold geographic distance from the client geographic location.

At operation 660, the method 600 may proceed with displaying the plurality of local merchants to the consumer using the client device associated with the consumer.

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120, see FIG. 1) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for local sourcing of goods in online commerce, comprising:
a secure switch operable to communicate bilaterally with at least one client device;
at least one gateway server electronically communicating with the secure switch, the least one gateway server comprising;
at least one processor; and
a memory storing processor-executable instructions, wherein the at least one processor is configured to implement the following operations upon executing the processor-executable instructions:
receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product;
receiving, from a plurality of prospective merchants, merchant geographic information associated with the plurality of prospective merchants relative to the query information for the product;
validating the merchant geographic information associated with the plurality of prospective merchants based on the query information for the product;
converting a portion of the plurality of prospective merchants to a plurality of verified merchants based on the validating operation;
filtering the plurality of the plurality of verified merchants based on the threshold geographic distance from the client geographic location, the filtering the plurality of verified merchants comprising selecting a plurality of local merchants, the plurality of local merchants being a fraction of the plurality of verified merchants that meet the threshold geographic distance from the client geographic location; and
displaying the plurality of local merchants to the consumer using the client device associated with the consumer.

2. The system for local sourcing of goods in online commerce according to claim 1, wherein the client geographic location is a delivery address.

3. The system for local sourcing of goods in online commerce according to claim 2, wherein the displaying the plurality of local merchants to the consumer using the client device associated with the consumer comprises displaying an adjustable radius of the geographic distance between the delivery address and the manufacturing geographic location of the product.

4. The system for local sourcing of goods in online commerce according to claim 2, wherein the displaying the plurality of local merchants to the consumer using the client device associated with the consumer comprises displaying an adjustable radius of the geographic distance between the delivery address and the retail geographic location of the product.

5. The system for local sourcing of goods in online commerce according to claim 2, wherein the displaying the plurality of local merchants to the consumer using the client device associated with the consumer comprises displaying both an adjustable radius of the geographic distance between the delivery address and the manufacturing geographic location of the product, and an adjustable radius of the geographic distance between the delivery address and the retail geographic location of the product.

6. The system for local sourcing of goods in online commerce according to claim 1, wherein the threshold geographic distance of the product from the client geographic location is further a function of order geographic location fulfillment for the product by an agent of the merchant.

7. The system for local sourcing of goods in online commerce according to claim 2, wherein the threshold geographic distance of the product from the client geographic location is further a function of delivery emissions for the product, the delivery emissions for the product being a function of emissions generated from travel of the product from the manufacturing geographic location of the product to the retail location of the product, and a function of emissions generated from travel of the product from the retail geographic location of the product to the delivery address.

8. The system for local sourcing of goods in online commerce according to claim 7, wherein the displaying the plurality of local merchants to the consumer using the client device associated with the consumer further comprises displaying the delivery emissions for the product from the plurality of local merchants.

9. The system for local sourcing of goods in online commerce according to claim 8, wherein the at least one processor is further configured to implement the operation receiving a threshold emissions criteria from the client, the threshold emissions criteria from the client being a maximum total emissions generated from travel of the product from the manufacturing geographic location of the product to the retail location of the product and emissions generated from travel of the product from the retail geographic location of the product to the delivery address.

10. The system for local sourcing of goods in online commerce according to claim 9,
wherein the product from the plurality of local merchants does not meet the threshold emissions criteria from the client; and
wherein the at least one processor is further configured to implement the operation of displaying an alternative product, the alternative product meeting the threshold emissions criteria from the client.

11. A method for local sourcing of goods in online commerce, comprising:
receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product;
receiving, from a plurality of prospective merchants, merchant geographic information associated with the plurality of prospective merchants relative to the query information for the product;
validating the merchant geographic information associated with the plurality of prospective merchants based on the query information for the product;
converting a portion of the plurality of prospective merchants to a plurality of verified merchants based on the validating operation;
filtering the plurality of the plurality of verified merchants based on the threshold geographic distance from the client geographic location, the filtering the plurality of verified merchants comprising selecting a plurality of local merchants, the plurality of local merchants being a fraction of the plurality of verified merchants that meet the threshold geographic distance from the client geographic location; and
displaying the plurality of local merchants to the consumer using the client device associated with the consumer.

12. The method for local sourcing of goods in online commerce according to claim 11, wherein the client geographic location is a delivery address.

13. The method for local sourcing of goods in online commerce according to claim 12, wherein the displaying the plurality of local merchants to the consumer using the client device associated with the consumer comprises displaying an adjustable radius of the geographic distance between the delivery address and the manufacturing geographic location of the product.

14. The method for local sourcing of goods in online commerce according to claim 12, wherein the displaying the plurality of local merchants to the consumer using the client device associated with the consumer comprises displaying an adjustable radius of the geographic distance between the delivery address and the retail geographic location of the product.

15. The method for local sourcing of goods in online commerce according to claim 12, wherein the displaying the plurality of local merchants to the consumer using the client device associated with the consumer comprises displaying both an adjustable radius of the geographic distance between the delivery address and the manufacturing geographic location of the product, and an adjustable radius of the geographic distance between the delivery address and the retail geographic location of the product.

16. The method for local sourcing of goods in online commerce according to claim 11, wherein the threshold geographic distance of the product from the client geographic location is further a function of order geographic location fulfillment for the product by an agent of the merchant.

17. The method for local sourcing of goods in online commerce according to claim 12, wherein the threshold geographic distance of the product from the client geographic location is further a function of delivery emissions for the product, the delivery emissions for the product being a function of emissions generated from travel of the product from the manufacturing geographic location of the product to the retail location of the product, and a function of emissions generated from travel of the product from the retail geographic location of the product to the delivery address.

18. The method for local sourcing of goods in online commerce according to claim 17, wherein the displaying the plurality of local merchants to the consumer using the client device associated with the consumer further comprises displaying the delivery emissions for the product from the plurality of local merchants.

19. The method for local sourcing of goods in online commerce according to claim 18, further comprising receiving a threshold emissions criteria from the client, the threshold emissions criteria from the client being a maximum total emissions generated from travel of the product from the manufacturing geographic location of the product to the retail location of the product and emissions generated from travel of the product from the retail geographic location of the product to the delivery address;
wherein the product from the plurality of local merchants does not meet the threshold emissions criteria from the client; and
wherein the at least one processor is further configured to implement the operation of displaying an alternative product, the alternative product meeting the threshold emissions criteria from the client.

20. A non-transitory computer readable medium having embodied thereon instructions being executable by at least one processor to perform a method for monitoring movement capabilities of a user using clinical mobility based assessments, the method comprising:
receiving query information for a product from a client device associated with a consumer, the query information for the product comprising a threshold geographic distance of the product from a client geographic location, the threshold geographic distance of the product from the client geographic location being a function of a manufacturing geographic location of the product and retail geographic location of the product;
receiving, from a plurality of prospective merchants, merchant geographic information associated with the plurality of prospective merchants relative to the query information for the product;
validating the merchant geographic information associated with the plurality of prospective merchants based on the query information for the product;
converting a portion of the plurality of prospective merchants to a plurality of verified merchants based on the validating operation;
filtering the plurality of the plurality of verified merchants based on the threshold geographic distance from the client geographic location, the filtering the plurality of verified merchants comprising selecting a plurality of local merchants, the plurality of local merchants being a fraction of the plurality of verified merchants that meet the threshold geographic distance from the client geographic location; and
displaying the plurality of local merchants to the consumer using the client device associated with the consumer.
